(19) United States
(12) Patent Application Publication
(10) Pub. No.: US 2012/0318602 A1
(43) Pub. Date: Dec. 20, 2012

(54) Exhaust System for Machine

(75) Inventor: Manoj Kumar Bada Ghar Wala, Montgomery, IL (US)

(73) Assignee: Caterpillar Inc., Peoria, IL (US)

(21) Appl. No.: 13/163,843

(22) Filed: Jun. 20, 2011

(51) Int. Cl. B60K 13/04; F01N 13/08

(52) U.S. Cl. 180/309; 60/272

(57) ABSTRACT

An exhaust system for an engine mounted within an engine compartment. The exhaust system may include a first tube having a venturi portion. The first tube may be connected to an outlet of the engine. The exhaust system may further include a second tube disposed over the first tube to define a flow passage in fluid communication with the engine compartment. Further, an opening may be defined on the second tube adjacent to the venturi portion of the first tube.

### TECHNICAL FIELD

The present disclosure relates to exhaust systems, and more particularly to an exhaust system configured to maintain pressure within an engine compartment of a machine.

### BACKGROUND

Machines, such as compactors, wheel loaders, track type tractors and the like, generally include an engine enclosed within an engine compartment. Exhaust gases coming from the engine are communicated to the environment through an exhaust pipe of an exhaust system. The exhaust system may also be configured to allow cooling air from the engine compartment to mix with the exhaust gases.

U.S. Pat. No. 7,793,495 (hereinafter referred to as '495 patent) discloses an exhaust system for a motor vehicle engine having mixing vent flaps in the exhaust pipe. The vent flap forms a portion of the exhaust pipe when closed and is pivotally 'attached along one edge to the exhaust pipe to open inwardly into the exhaust pipe to constrict and accelerate flow in the exhaust pipe to allow outside air to be drawn into the exhaust pipe. However, the '495 patent does not disclose a system to maintain an optimum pressure inside the engine compartment.

### SUMMARY

In one aspect, the present disclosure provides an exhaust system for an engine mounted within an engine compartment. The exhaust system may include a first tube having a venturi portion. The first tube may be connected to an outlet of the engine. The exhaust system may further include a second tube disposed over the first tube to define a flow passage in fluid communication with the engine compartment. Further, an opening may be defined on the second tube adjacent to the venturi portion of the first tube.

Other features and aspects of the present disclosure will be apparent from the following description and the accompanying drawings.

### BRIEF DESCRIPTION OF THE DRAWINGS

FIG. 1 is a side view of a machine having an exhaust system, according to an aspect of this disclosure:

FIG. 2 is a cross-sectional side view of the exhaust system, according to an aspect of this disclosure: and,

FIG. 3 is a cross-sectional side view of the exhaust system, according to another aspect of this disclosure.

### DETAILED DESCRIPTION

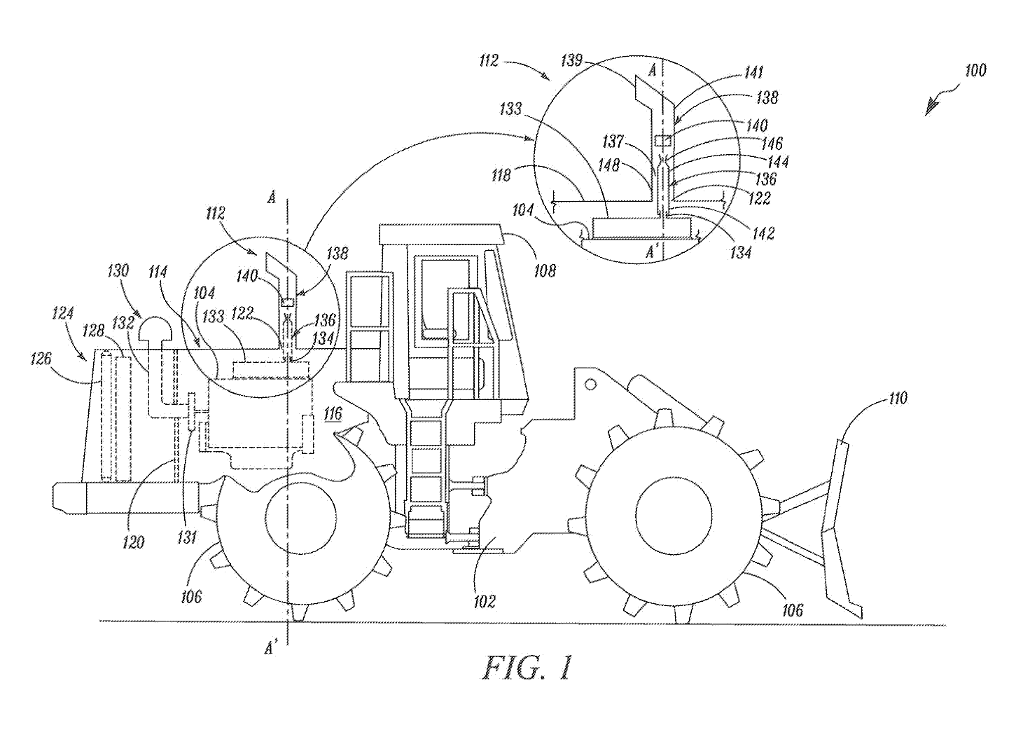

FIG. 1 shows a side view of a machine 100, according to an aspect of the present disclosure. The machine 100 may include a tracked or a wheeled vehicle, for example, but not limited to, track type loaders, mining shovels, wheel loaders, hack hoe loaders, motor graders, track type tractors, wheeled tractors, pavers, excavators, material handlers, forestry machines, or any other machine using an engine. The machine 100 may also be stationary, such as a generator or pump. In an embodiment, as shown in FIG. 1, the machine 100 may embody a landfill compactor which may be used for spreading waste evenly over a landfill, and/or to compact the waste to reduce its volume and help in stabilizing the landfill.

The machine 100 includes a machine frame 102, an engine 104, a plurality of ground engaging members 106, an operator compartment 108, a work implement 110, and an exhaust system 112. The machine frame 102 supports the engine 104, and the operator compartment 10R.

The machine 100 further includes an engine compartment 114 carried on the machine frame 102, such that the engine 104 is mounted within the engine compartment 114. The engine compartment 114 may include spaced apart opposed side walls 116, a top wall 118, and a rear wall 120. The spaced apart opposed side walls 116, the top wall 118, the rear wall 120 define a space within the engine compartment 114. The engine 104 may be positioned within the space, such that there is a space between the top of the engine 104 and the top wall 118 of the engine compartment 114. Further, an aperture 122 may be provided on the top wall 118 of the engine compartment 114.

The engine 104 is operationally coupled to the plurality of ground engaging members 106 such that the engine 104 may drive the plurality of ground engaging members 106, thereby moving the machine 100 within a work area. The engine 104 may also provide power to auxiliary components of the machine 100, such as, machine hydraulics and electromechanical components. The engine 104 may be a petrol engine, diesel engine, or any other kind of engine utilizing combustion of fuel for generation of power.

Further, a radiator fan assembly 124 may be provided. The radiator fan assembly 124 includes a radiator 126 having a coolant flowing therein, and a fan 128. The fan 128 may be driven by power from the engine 104 via a transmission assembly (e.g., belt drive, gear drive, or a combination of these). The coolant circulates within the radiator 126 and the fan 128 moves air in a direction across the radiator 126, such that the air flows through the radiator 126 and cools the coolant. The rear wall 120 separates the radiator fan assembly 124 from the engine compartment 114.

Furthermore, a suction fan assembly 130 may be provided, which may also be associated with the engine compartment 114. The suction fan assembly 130 includes a suction fan 131 and a suction pipe 132. The suction fan 131 may be driven by electric or hydraulic means. The suction pipe 132 passes through the rear wall 120. The suction fan 131 may be configured to draw cooling air from the atmosphere through the suction pipe 132. The cooling air passes over the engine 104 before getting eventually released. Further, the cooling air drawn from the suction fan 131 also pressurizes the engine compartment 114.

During operation of the engine 104, the exhaust system 112 facilitates the release of exhaust gases from the engine 104 to the environment. Moreover, the exhaust system 112 may also be associated with the engine compartment 114 for facilitating the release of the cooling air from the engine compartment 114 to the environment. Further, an exhaust muffler 133 may be connected to the engine 104. The exhaust muffler 133 includes an outlet 134. The outlet 134 includes a top periphery and has an axis A-A′, orthogonal to a top of the engine 104. The outlet 134 provides a path for the exhaust gases from the engine 104. In an alternative embodiment of the present disclosure, an emissions module may be present instead of the exhaust muffler 133. The emissions module may have an outlet providing a path to the exhaust gases from the engine 104.

The exhaust system 112 of the machine 100 may further include a first tube 136 connected to the outlet 134. The first tube 136 may be configured to receive the exhaust gases from the outlet 134, during the operation of the engine 104. The exhaust system 112 further includes a second tube 138. The second tube 138 may be disposed over the first tube 136 to define a flow passage 137 between the first and second tubes 136 and 138 in fluid communication with the engine compartment 114. The cooling air from the engine compartment 114 may flow through the flow passage 137 defined between the first tube 136 and the second tube 138. Further, the second tube 138 may include a bent portion 139 at a free end portion 141 of the second tube 138. The free end portion 141 may direct the exhaust gases away from the operator compartment 108.

In an embodiment of the present disclosure, the first tube 136 includes a first end portion 142 and a second end portion 144. The first end portion 142 of the first tube 136 may be connected to the outlet 134. The second end portion 144 of the first tube 136 extends through the aperture 122 provided on the top wall 118 of the engine compartment 114. A venturi portion 146 may be formed on the first tube 136. The venturi portion 146 may be proximate to the second end portion 144 of the first tube 136. Further, the venturi portion 146 of the first tube 136 is a portion of reduced cross-sectional area. Consequently, the venturi portion 146 causes the exhaust gases coming from the engine 104 to experience the venturi effect which results in an increase in flow velocity of the exhaust gases and a corresponding decrease in pressure of the exhaust gases.

Further, an end portion 148 of the second tube 138 may be connected to the top wall 118 of the engine compartment 114, such that a periphery of the aperture 122 is connected to the end portion 148 of the second tube 138. In an embodiment of the present disclosure, the second tube 138 is may be disposed concentrically over the first tube 136, such that the flow passage 137 of the cooling air may be defined by an external surface of the first tube 136 and the internal surface of the second lube 138. Each of the first tube 136 and the second tube 138 may have a hollow cylindrical configuration, having different diameters. However it shall be evident to those skilled in the art that the first tube 136 and the second tube 138 may be of any other shapes or cross-sections without deviating from the scope of the present disclosure.

According to an embodiment of the present disclosure, the exhaust system 112 may include an opening 140 defined on the second tube 138. The opening 140 on the second tube 138 may be adjacent to the venturi portion 146 of the first tube 136. The opening 140 on the second tube 138 may allow ambient air to enter the second tube 138. In an alternative embodiment of the present disclosure, a plurality of openings may be defined around the second tube 138. Each of the plurality of openings may function as the opening 140 to allow the ambient air to enter the second tube 138.

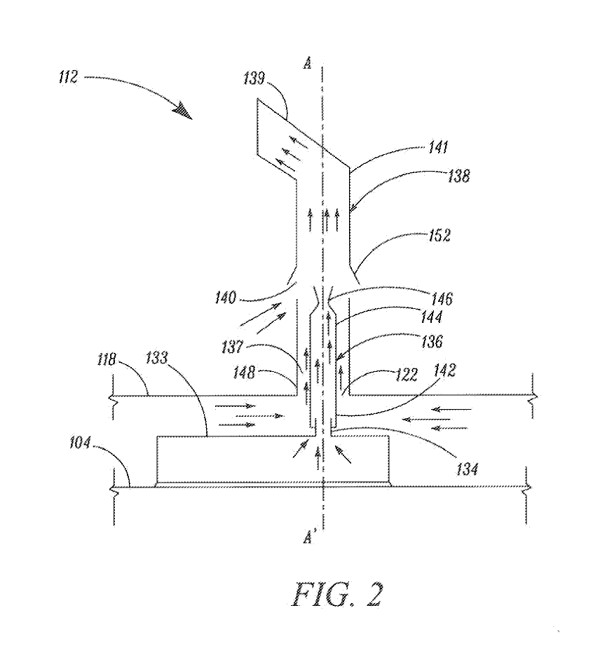

Referring now to FIG. 2, according to an embodiment of the present disclosure, a louver 152 may be provided on the second tube 138. The louver 152 may extend angularly from an external surface of the second tube 138 at the opening 140. In an aspect of the present disclosure, an inclination of the louver 152 with respect to the second tube 138 is configured to be altered. The change in the inclination of the louver 152 may be enabled by a hinged connection between the louver 152 and the second tube 138. Alternatively, any other connection that enables angular movement of the louver 152 may be provided between the louver 152 and the second tube 138. Further, such change in the inclination of the louver 152 may be dependent upon a pressure within the engine compartment 114. For example, if the pressure within the engine compartment 114 is lower than a threshold pressure, the inclination of the louver 152 may be altered to introduce more ambient air. Thus, the ambient air may restrict the outflow of the cooling air from the engine compartment 114, and prevents a decrease in pressure within the engine compartment 114.

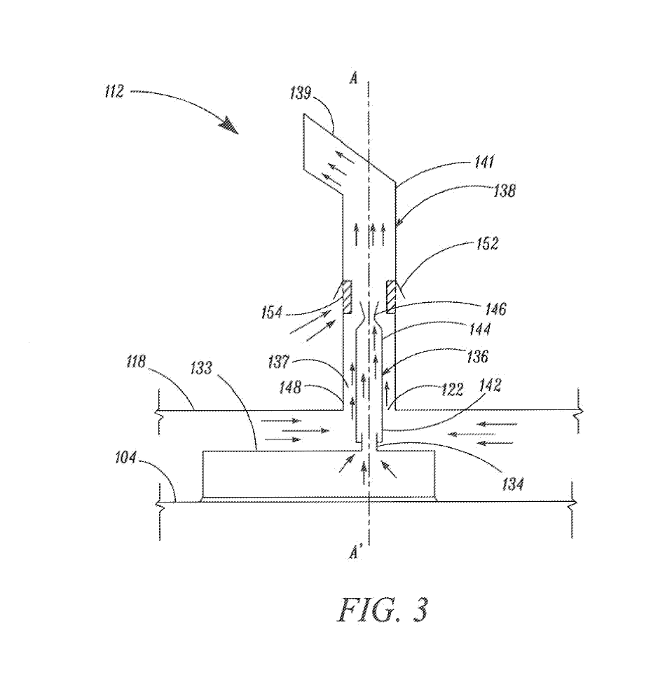

Referring now to FIG. 3, the exhaust system 112 further includes a screen 154 disposed over the opening 140. The screen 154 may be configured to preclude debris and other impurities from entering the second tube 138 through the opening 140. The screen 154 may however, allow the ambient air to enter the second tube 138. In an embodiment of the present disclosure, the screen 154 may be in the form of a squirrel cage screen.

### INDUSTRIAL APPLICABILITY

In work machines, such as landfill compactors and the like, that work around debris, it is frequently seen that, a pressure differential is created within an engine compartment such as the engine compartment 114. This pressure difference may cause the debris and other impurities to get drawn into the engine compartment 114. The exhaust system 112 of the present disclosure assists in maintaining the pressure within the engine compartment 114 at a desired level. The pressure maintained within the engine compartment 114 may help prevent the debris or other impurities from getting sucked into the engine compartment 114. Therefore, the exhaust system 112 may help prevent overheating within the engine compartment 114. The exhaust system 112 also assists in adequately exhausting the exhaust gases from the engine 104 and the cooling air from the engine compartment 114. Further, the disclosed exhaust system 112 facilitates mixing of the exhaust gases with the cooling air and the ambient air before release to the environment.

During operation of the engine 104, the exhaust gases from the outlet 134 may be received by the first tube 136. Simultaneously, the suction fan assembly 130 may supply pressurized cooling air to the engine compartment 114. The cooling air may flow through the space within the engine compartment 114, thereby cooling the engine 104. Subsequently, the cooling air may flow through the flow passage 137 defined by the first tube 136 and the second tube 138. Simultaneously, the ambient air from the environment may enter the second tube 138 through the opening 140. The screen 154 disposed over the opening 140 may further assist in preventing debris and other impurities from entering the second tube 138 along with the ambient air. A region of low pressure created in the venturi portion 146 causes the ambient air from the environment to get sucked into the second tube 138. Entry of the ambient air from the opening 140 into the second tube 138 limits the outflow of the cooling air from the engine compartment 114, due to which the pressure within the engine compartment 114 is maintained. The pressure maintained within the engine compartment 114 helps prevent precludes debris or other impurities from getting sucked into the engine compartment 114.

Further, the ambient air and the cooling air mix with the exhaust gases in the second tube 138, prior to release of the exhaust gases to the environment. The mixing of the ambient air, cooling air, and exhaust gases results in formation of a cooled mixture of gases. The cooled mixture of gases is released to the environment through the bent portion 139 of the second tube 138. The cooled mixture of gases may prevent debris from burning or melting on the exhaust system 112. The efficient mixing of ambient air, cooling air, and exhaust gases may prevent backpressure in the exhaust system 112.

The exhaust system 112 described above finds application in machines such as compactors, track type loaders, mining shovels, wheel loaders, back hoe loaders, wheeled tractors, pavers, excavators, material handlers, or any other machines that experience problems associated with debris collecting in the engine compartment 114 and thermal issues arising due to such debris collection on the engine hot surfaces. In addition, the exhaust system 112 of the present disclosure may be installed with any existing machine without any need of an extensive and costly redesign of the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust system for an engine mounted within an engine compartment, the exhaust system comprising:
a first tube having a venturi portion, the first tube being connected to an outlet of the engine;
a second tube disposed over the first tube to define a flow passage in fluid communication with the engine compartment; and
an opening defined in the second tube adjacent to the venturi portion of the first tube.

2. The exhaust system of claim 1, wherein ambient air passes through the opening into the flow passage.

3. The exhaust system of claim 1, wherein cooling air from the engine compartment flows through the flow passage.

4. The exhaust system of claim 1, wherein exhaust gases from the outlet of the engine pass through the first tube into the flow passage.

5. The exhaust system of claim 1, wherein the opening on the second tube includes a louver extending angularly from an external surface of the second tube.

6. The exhaust system of claim 5, wherein an inclination of the louver with respect to the external surface is configured to be altered.

7. The exhaust system of claim 1 further including a screen disposed over the opening.

8. The exhaust system of claim 1, wherein the second tube further includes a bent portion at a free end portion of the second tube.

9. A machine comprising:
an engine compartment;
an engine mounted within the engine compartment, the engine including an outlet; and
an exhaust system, the exhaust system including:
a first tube having a venturi portion, the first tube being connected to the outlet of the engine;
a second tube disposed over the first tube to define a flow passage in fluid communication with the engine compartment; and
an opening defined on of the second tube adjacent to the venturi portion of the first tube.

10. The machine of claim 9, wherein ambient air passes through the opening into the flow passage.

11. The machine of claim 9, wherein cooling air from the engine compartment flows through the flow passage.

12. The machine of claim 9, wherein exhaust gases from the outlet of the engine pass through the first tube into the flow passage.

13. The machine of claim 9, wherein the opening of the second tube includes a louver extending angularly from an external surface of the second tube.

14. The machine of claim 9, wherein an inclination of the louver with respect to the second tube is configured to be altered.

15. The machine of claim 9 further including a screen disposed over the opening.

16. The machine of claim 9, wherein the second tube further includes a bent portion at a free end portion of the second tube.

17. An exhaust system for an engine mounted within an engine compartment, the exhaust system comprising:
a first tube having a venturi portion, the first tube being connected to an outlet of the engine for receiving exhaust gases from the outlet;
a second tube disposed over the first tube to define a flow passage in fluid communication with the engine compartment, the flow passage allows cooling air from the engine compartment to flow therethrough; and
an opening defined on the second tube adjacent to the venturi portion of the first tube, the opening allowing ambient air to enter the flow passage.

18. The exhaust system of claim 17, wherein the opening on the second tube includes a louver extending angularly from an external surface of the second tube.

19. The exhaust system of claim 18, wherein an inclination of the louver with respect to the external surface is configured to be altered.

20. The exhaust system of claim 17 further including a screen disposed over the opening.
